(19) United States
(12) Patent Application Publication
(10) Pub. No.: US 2012/0141910 A1
(43) Pub. Date: Jun. 7, 2012

(54) Multiple Membrane Layers in a Fuel Cell Membrane-Electrode Assembly

(75) Inventors: Nengyou Jia, Hillsboro, OR (US); Jason M. Tang, Hillsboro, OR (US); Yang Song, Portland, OR (US)

(73) Assignee: CLEAREDGE POWER, INC., Hillsboro, OR (US)

(21) Appl. No.: 13/371,050

(22) Filed: Feb. 10, 2012

(51) Int. Cl. H01M 8/10; H01M 8/00

(52) U.S. Cl. 429/482; 429/535

(57) ABSTRACT

Embodiments are disclosed herein that relate to PEM fuel cells comprising membrane-electrode assemblies having plural membrane layers. For example, one disclosed embodiment provides a fuel cell including an anode, a cathode, and a multi-layer membrane disposed between the anode and the cathode, the multi-layer membrane comprising two or more polymer membranes layers. The fuel cell further comprises an electrolyte within the multi-layer membrane.

### BACKGROUND

In some fuel cells, a polymer-electrolyte membrane (PEM) is disposed between an anode, where fuel is electrochemically oxidized, and a cathode, where oxygen is electrochemically reduced. The PEM enables ions evolved at the anode to travel to the cathode, resulting in a charge-balanced redox reaction between the fuel and the oxygen. In typical usage, a catalytic and/or reactant-retentive structure may be bonded to each side of the membrane—i.e., an anodic structure bonded to the anode side and a cathodic structure bonded to the cathode side. Such structures, together with the PEM in between, comprise the membrane-electrode assembly (MEA) of the fuel cell.

One type of PEM, attractive for its extended operating-temperature range, is the PBI-PA membrane. This membrane comprises a polybenzimidazole (PBI) film in which a significant quantity of phosphoric acid (H₃PO₄, PA) or other suitable electrolyte may be sorbed. Fuel cells utilizing such membranes may be referred to as high-temperature PEM fuel cells, or HT-PEM fuel cells.

The ionic conductivity of a polymer-electrolyte membrane is dependent upon a volumetric amount of electrolyte in the membrane. Accordingly, a PEM engineered for use in a fuel cell may be intentionally doped with excess electrolyte. In this manner, the MEA may store a sufficient amount of PA to offer an acceptably long usable lifetime despite gradual PA loss that may occur.

### SUMMARY

Embodiments are disclosed herein that relate to PEM fuel cells comprising membrane-electrode assemblies having plural membrane layers. For example, one disclosed embodiment provides a fuel cell comprising an anode, a cathode, and a multi-layer membrane disposed between the anode and the cathode, the multi-layer membrane comprising two or more polymer membranes layers. The fuel cell further comprises an electrolyte within the multi-layer membrane.

The summary above is provided to introduce a selected part of this disclosure in simplified form, not to identify key or essential features. The claimed subject matter, defined by the claims, is not limited to the content of this summary or to implementations that address problems or disadvantages noted herein.

### BRIEF DESCRIPTION OF THE DRAWINGS

FIG. 1 illustrates a schematic diagram of an example embodiment of a fuel cell system.

FIG. 2 illustrates a schematic depiction of an embodiment of an MEA comprising plural membrane layers.

FIG. 3 illustrates a schematic depiction of an embodiment of an MEA comprising plural membrane layers and a reinforcing layer disposed between the membrane layers.

FIG. 4 shows a flow diagram depicting an embodiment of a method of making an MEA comprising plural membrane layers.

FIG. 5 shows a graph illustrating output voltage as a function of time for a fuel comprising a double layer MEA compared to a fuel cell comprising a single layer MEA.

### DETAILED DESCRIPTION

The performance of a HT-PEM fuel cell may be dependent upon various factors, including but not limited to the ionic conductivity of the membrane and the cathode performance of the fuel cell. As mentioned above, the ionic conductivity of a MEA for a fuel cell may be dependent upon the volumetric amount of electrolyte in the membrane. Thus, a fuel cell may utilize a relatively higher electrolyte level in the membrane to achieve a higher fuel cell performance relative to a lesser electrolyte level in a similar fuel cell.

However, increasing the electrolyte content in a membrane may detrimentally impact the mechanical strength of the membrane. This may reduce the resistance of a membrane to damage from cell assembly processes, thermal cycling and other such factors. Further, the use of excess electrolyte in the membrane also may flood the cathode catalyst layer of the MEA with electrolyte during cell assembly, which may cause lower cell performance and faster cell degradation. In particular, excess PA present on the cathode side of the membrane may flood the reactant-retentive structure bonded to the membrane, restricting oxygen diffusion and occluding the catalytic sites where oxygen reduction takes place. Excess PA on the cathode side may also encourage dihydrogen phosphate (H₂PO₄⁻) to adsorb on the catalytic sites, causing contamination. These factors may significantly degrade the operating voltage of the fuel cell, which is normally limited by cathode kinetics.

Accordingly, various embodiments are disclosed herein that relate to addressing such issues via the use of a multi-layer membrane structure in a fuel cell MEA. Briefly, a MEA may comprise two or more polymer membranes layers disposed between the cathode assembly and the anode assembly. The use of multiple membrane layers in a MEA may allow a volumetric amount of electrolyte in the fuel cell to be increased without increasing an electrolyte doping level. This may help to maintain a desired electrolyte level in the membrane without flooding the cathode structures with electrolyte, while reducing a number of manufacturing steps used to impregnate a desired volumetric amount of electrolyte into the membrane, as well as into electrode catalyst layers. As HT-PEM fuel cells often operate in a relatively lower current density region, any increase in ionic resistance caused by membrane thickness may result in a negligible performance loss.

Further, in some embodiments, different volumetric amounts of electrolyte may be added to the membranes in such a MEA to form an electrolyte concentration gradient across the multi-layer membrane structure. The use of an electrolyte concentration gradient that decreases in a direction from the anodic structure to the cathodic structure may help to prevent flooding of the cathodic structure during cell assembly while maintaining a suitably high electrolyte quantity for desired cell performance.

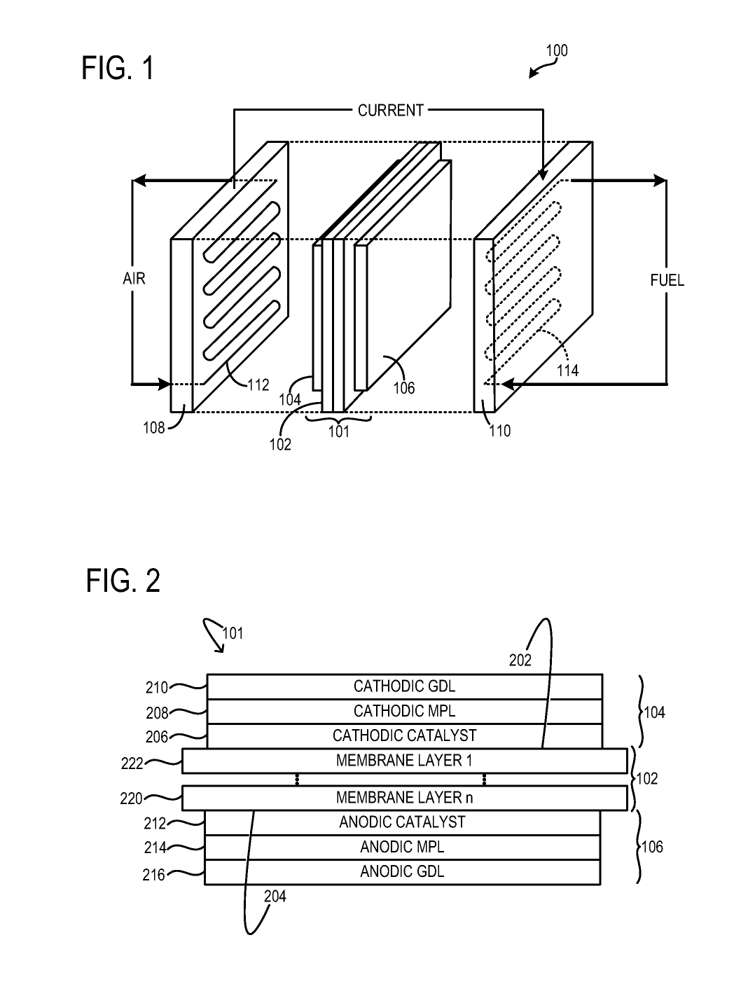

FIG. 1 shows a schematic diagram depicting an exploded view of an example fuel cell system 100. Fuel cell system 100 comprises a MEA 101 comprising a multi-layer PEM 102 disposed between a cathodic structure 104 and an anodic structure 106. The fuel cell system 100 also comprises a conductive cathodic bipolar plate 108 (or end plate) disposed in contact with cathodic structure 104, and an anodic bipolar plate 110 (or end plate) disposed in contact with anodic structure 106. Each of the cathodic bipolar plate 108 and the anodic bipolar plate 110 includes reactants flow channels, respectively shown at 112 and 114, to distribute reactants to the respective electrodes. While the schematic depiction in FIG. 1 shows a single fuel cell, it will be understood that a fuel cell system may comprise multiple fuel cells arranged in series and/or in parallel to achieve desired current and voltage output characteristics. It further will be understood that a fuel cell system may comprise any other suitable components, such as controllers, fuel reformers, etc., not described herein.

FIG. 2 shows a schematic view of the MEA 101 of FIG. 1 in more detail. The MEA 101 comprises the multi-layer PEM 102, the cathodic structure 104 and the anodic structure 106. The cathodic structure 104 is arranged on a first surface 202 of the multi-layer PEM 102, and the anodic structure 106 is arranged on a second surface 204 opposite the first surface 202. As shown in FIG. 2, the cathodic structure 104 includes a cathodic catalyst layer 206, a cathodic microporous layer (MPL) 208 and a cathodic gas diffusion layer (GDL) 210. Likewise, the anodic structure 106 includes an anodic catalyst layer 212, an anodic MPL 214, and an anodic GDL 216.

The multi-layer PEM 102 is shown as comprising an arbitrary number n of membrane layers, wherein n is equal to or greater than two. Each membrane layer of the multi-layer PEM 102 comprises a quantity of an electrolyte, such as phosphoric acid or other suitable electrolyte. In some embodiments, the electrolyte content may be equal or otherwise similar in each membrane layer. In other embodiments, the electrolyte content may vary between layers, for example, to establish an electrolyte concentration gradient across the multi-layer MEA 102. Adding a greater volumetric amount of electrolyte to a membrane layer 220 closer to the anodic structure 106 than to a membrane layer closer 222 to the cathodic structure 104 during manufacturing may help to lessen the possibility of flooding the cathode structure with electrolyte during manufacturing. This may help to reduce the degradation rate of a fuel cell. Further, the use of multiple membrane layers with or without an electrolyte concentration gradient may help to increase a volumetric content of electrolyte without scarifying the mechanical strength of the overall multi-layer PEM 102.

Additionally, as mentioned above, the interfaces between the membrane layers may help to accommodate membrane expansion and contraction during thermal cycles, which further may help to extend the lifetime of a fuel cell compared to a fuel cell comprising a single layer PEM, especially where different types of membranes with different thermal expansion characteristics are used. Further, the greater volumetric quantity of electrolyte in the multi-layer PEM compared to a single-layer PEM may help to simplify manufacturing, as it may allow the omission of a separate electrolyte doping process for the cathodic and anodic structures. Also, the greater overall quantity of electrolyte in a multi-layer PEM compared to a single layer PEM may allow a longer operating lifetime for a fuel cell, as electrolyte lost from the electrode structures may be replenished from the multi-layer membrane.

Any suitable quantities of electrolyte may be added to the layers of a multi-layer PEM. For example, in some embodiments comprising a two-layer PBI membrane doped with phosphoric acid, the membrane layer in contact with the cathode initially may have less than 7 mg phosphoric acid per cubic centimeter of membrane at the time of cell assembly, while the membrane layer in contact with the anode initially may have greater than 15 mg phosphoric acid per cubic centimeter of membrane at the time of cell assembly. It may be desirable to utilize sufficient phosphoric acid in each membrane layer to yield a total multi-layer MEA volumetric acid content of at least 15 mg/cm², and as high as 20-28 mg/cm² in some embodiments. After assembly and during use, the volumetric amounts of phosphoric acid may rebalance, which may help to enhance the beginning-of-life (BOL) performance of the fuel cell and extend the lifetime of the fuel cell. It will be understood that these particular volumetric amounts and ranges are described for the purpose of example, and are not intended to be limiting in any manner.

Each membrane of the multi-layer PEM may be formed from any suitable material. For example, as mentioned above, each membrane layer may be formed from PBI or a PBI derivative. Other example membrane materials include polybenzoxazine (PBOA) and poly(2,5-benzimidazole) (ABPBI). In some embodiments, each membrane is made from a same material as other membranes in a multi-layer MEA, while other embodiments one or more membrane layers may be made from a different material or materials than other membrane layers. Further, in some embodiments, one or more membrane layers may include additional structures. As one non-limiting example, one or more membrane layers may include a supportive structure, such as a silicon carbide matrix or other matrix.

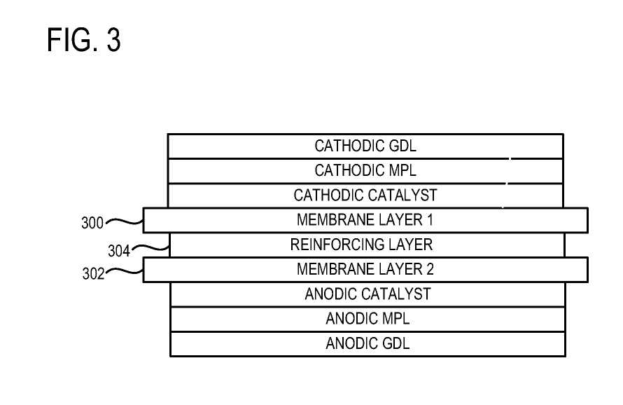

Likewise, other reinforcing structures may be used in a multi-layer MEA. For example, FIG. 3 illustrates an embodiment of a MEA that comprises a first membrane layer 300, a second membrane layer 302, and a reinforcing layer 304 disposed between the first membrane layer 300 and the second membrane layer 302. The reinforcing layer 304 may comprise any suitable material. Suitable materials may include but are not limited to materials that do not impede ionic current flow to an undesirable degree, that are stable at operating temperatures, and/or that are inert to the electrolyte and membrane materials. One non-limiting example of a suitable material for the reinforcing layer 304 is poly(tetrafluoroethylene) (PTFE). While the depicted embodiment shows two membrane layers with one reinforcing layer disposed there between, it will be understood that in other embodiments any suitable number of membrane layers and any suitable number and arrangement of reinforcing layers may be utilized. Further, in yet other embodiments, a reinforcing layer may be omitted.

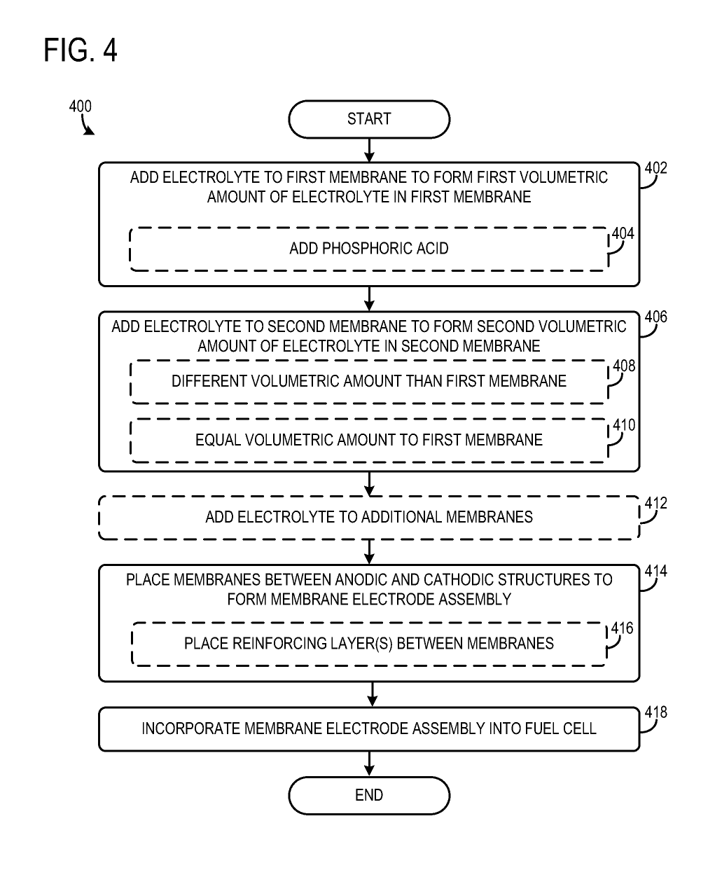

FIG. 4 shows a flow diagram depicting an example embodiment of a method 400 of making a multi-layer MEA. Method 400 comprises, at 402, adding electrolyte to a first membrane layer to form a first volumetric amount of electrolyte in the first membrane. In some embodiments, for example, where a PBI, PBI derivative, or other similar material is used as a membrane layer, adding the electrolyte may comprise adding phosphoric acid to the membrane, as indicated at 404. In other embodiments, any other suitable electrolyte may be used with any other suitable membrane material.

Method 400 further comprises, at 406, adding electrolyte to a second membrane layer to form a second volumetric amount of electrolyte in the second membrane layer. In some embodiments, as shown at 408, the second membrane layer may comprise a different volumetric amount of electrolyte than the first membrane layer. In other embodiments, as shown at 410, the second membrane layer may comprise an equal volumetric amount (e.g. within a suitable tolerance range) of electrolyte as the first membrane layer. Further, in embodiments with three or more membrane layers, method 400 may comprise, at 412, adding electrolyte to additional membrane layers. It will be understood that some amount of electrolyte also may be added to the cathodic and anodic structures in order to facilitate a MEA conditioning process during initial fuel cell use.

After electrolyte has been added to membrane layers, method 400 comprises, at 414, placing the membrane layers between anodic and cathodic structures to form the MEA. This may further comprise placing reinforcing layers between membrane layers, as indicated at 416, and also may comprise arranging membrane layers having different volumetric amounts of electrolyte in a desired arrangement. For example, layers with lower volumetric amounts of electrolyte may be placed closer to the cathodic structure, while layers with higher volumetric amounts of electrolyte may be placed closer to the anodic structure. The membrane layers and any reinforcing layers may be joined into an MEA via any suitable process, including but not limited to via the application of heat and pressure. After forming the MEA, the MEA may be incorporated into a fuel cell, as shown at 418. Such a fuel cell may then be used for generating electric current. Further, such a fuel cell also may be used for hydrogen gas purification.

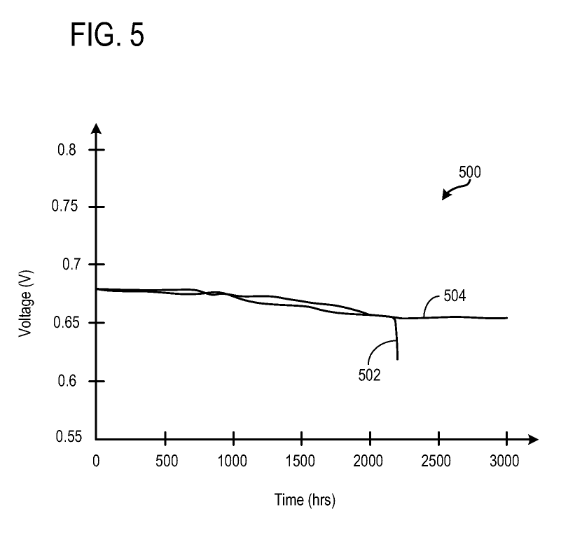

FIG. 5 shows a graph 500 illustrating the output voltages as a function of operating time for fuel cells comprising a single layer MEA and a double layer MEA. The single layer MEA fuel cell lifetime performance is shown at 502, and the double layer MEA fuel cell lifetime performance is shown at 504. The single layer MEA was prepared by initially doping the anodic structure with 6.4 mg/cm² phosphoric acid and adding 19.7 mg/cm² phosphoric acid to an AB-PBI membrane. The cathodic structure was not doped. The double layer MEA was prepared by adding a total of 25 mg/cm² phosphoric acid to two AB-PBI membrane layers. The cathodic and anodic structures were not doped prior to assembling the double layer MEA.

From the graph 500, it can be seen that the single layer MEA and the double layer MEA fuel cells showed similar performance behavior up to 2100 hours of cell operation. However, the single layer MEA fuel cell suffered an internal crossover with further cell operation. In contrast, the double layer MEA fuel cell continued operating beyond this point with a reasonable decay rate in cell performance. Cell resistance measurements indicated that the double layer membrane increased the cell resistance only slightly (e.g. by ˜20 mΩ.cm2). As the cell operated at a low current density region (<0.2 A/cm²), the effect of the resistance change on the overall cell performance was negligible. Thus, it can be seen that suitable BOL performance and extended durability may be achieved via the use of a multi-layer MEA without the extra manufacturing steps of doping the anodic and/or cathodic structures before assembling the MEA.

It will be understood that process steps described and/or illustrated herein may, in some embodiments, be omitted without departing from the scope of this disclosure. Likewise, the indicated sequences of the process steps are provided for ease of illustration and description, and may be performed in any suitable order. Further, one or more of the illustrated actions, functions, or operations may be omitted or performed repeatedly, depending on the particular strategy being used.

It further will be understood that the articles, systems, and methods described herein are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A fuel cell, comprising:
an anode;
a cathode;
a multi-layer membrane disposed between the anode and the cathode, the multi-layer membrane comprising two or more polymer membrane layers; and
an electrolyte within the multi-layer membrane.

2. The fuel cell of claim 1, wherein the electrolyte comprises phosphoric acid.

3. The fuel cell of claim 1, wherein the multi-layer membrane comprises a first membrane layer having a first volumetric amount of electrolyte, and a second membrane layer having a second volumetric amount of electrolyte that is different than the first volumetric amount.

4. The fuel cell of claim 3, wherein the first membrane layer is located adjacent to the cathode and the second membrane layer is located adjacent to the anode, and wherein the first volumetric amount is lower than the second volumetric amount.

5. The fuel cell of claim 1, wherein the polymer membranes comprises one or more of PBI and a PBI derivative.

6. The fuel cell of claim 1, wherein the multi-layer membrane comprises more than two membrane layers.

7. The fuel cell of claim 1, further comprising a reinforcing layer disposed between the first membrane layer and the second membrane layer.

8. The fuel cell of claim 1, wherein one or more membrane layers comprise an inorganic matrix.

9. A fuel cell, comprising:
an anode;
a cathode;
a first membrane layer disposed between the anode and the cathode and comprising a first volumetric amount of electrolyte; and
a second membrane layer disposed between the anode and the cathode and comprising a second volumetric amount of electrolyte that is different than the first volumetric amount.

10. The fuel cell of claim 9, wherein the first membrane layer is located adjacent the cathode, the second membrane layer is located adjacent the anode, and first volumetric amount of electrolyte is lower than the second volumetric amount of electrolyte.

11. The fuel cell of claim 9, wherein the electrolyte comprises phosphoric acid.

12. The fuel cell of claim 9, wherein the first membrane layer and the second membrane layer each comprises one or more of PBI and a PBI derivative.

13. The fuel cell of claim 9, further comprising a polymer reinforcing structure disposed between the first membrane layer and the second membrane layer.

14. The fuel cell of claim 13, wherein the third membrane comprises a different volumetric amount of electrolyte than the first membrane layer and the second membrane layer.

15. A method of making a membrane electrode assembly for a fuel cell, the method comprising:
adding electrolyte to a first membrane layer to form a first volumetric amount of electrolyte in the first membrane layer;
adding electrolyte to a second membrane layer to form a second volumetric amount of electrolyte in the second membrane layer; and
placing the first membrane layer and second membrane layer between an anode and a cathode to form the membrane electrode assembly.

16. The method of claim 15, wherein adding electrolyte to the first membrane layer and to the second membrane layer comprises adding phosphoric acid to the first membrane layer and to the second membrane layer.

17. The method of claim 15, wherein the first volumetric amount is different from the second volumetric amount.

18. The method of claim 15, wherein one or more of the first membrane layer and the second membrane layer comprises an inorganic matrix.

19. The method of claim 15, further comprising placing a reinforcing layer between the first membrane layer and the second membrane layer.

20. The method of claim 15, wherein the first membrane layer and the second membrane layer comprise one or more of PBI and a PBI derivative.
